(19) United States
(12) Patent Application Publication
(10) Pub. No.: US 2020/0193344 A1
(43) Pub. Date: Jun. 18, 2020

(54) FACILITATING CONTACTLESS CAR SHARING

(71) Applicant: Thunder Power New Energy Vehicle Development Company Limited, Central (HK)

(72) Inventor: Wellen Sham, Taipei City (TW)

(21) Appl. No.: 16/702,584

(22) Filed: Dec. 4, 2019

Related U.S. Application Data
(60) Provisional application No. 62/778,307, filed on Dec. 12, 2018.

(51) Int. Cl. G06Q 10/06; H04W 12/06; B60R 25/24

(52) U.S. Cl. CPC G06Q 10/06311; G05D 1/0276; B60R 25/24; H04W 12/06

(57) ABSTRACT

Embodiments facilitate contactless car sharing. A user device may be configured to request using a vehicle at a desired time. The request can be transmitted to a computer server associated with a car sharing service provider. The computer server may request the user device to transmit a number of keep-alive messages before the vehicle is dispatched to the pickup location, and another number of keep-alive messages while the vehicle is being dispatched to the pickup location. In some embodiments, after the vehicle has arrived at the pickup location, the computer server may request the user device to generate another request for accessing the vehicle at the pickup location.

### CROSS-REFERENCES TO RELATED APPLICATIONS

The present application claims priority to U.S. Patent Application No. 62/778,307, filed on Dec. 12, 2018, entitled “FACILITATING CONTACTLESS CAR SHARING”, which is incorporated by reference herein for all purposes.

### FIELD OF THE DISCLOSURE

The Disclosure generally relates to a car sharing network.

### BACKGROUND OF THE DISCLOSURE

Facilitating car sharing is generally known in the art. A traditional form of car sharing is car rental services. Programs, websites and apps have been developed to facilitate a user to reserve a rental car in advance. For example, a user can reserve a rental car online at a website provided by a rental car company. The reservation information is recorded in a database on the rental company and as well as delivered to the pickup location. After the user arrives at the pickup location, a clerk can call up the reservation information and complete the rental transaction with the user. After the rental transaction is completed, the user is then permitted to walk to the car for pickup.

Some other car sharing is facilitated similarly. For example, some car sharing services give their members access cards for accessing shared cars. The access cards typically have a wireless chip. After a member reserves a car, the member can access the car using the access card at a time of the reservation. The car is typically parked at a home location, which may be one of the following: a reserved parking space located on a street, driveway, or neighborhood parking lot in the member's area.

### SUMMARY OF THE DISCLOSURE

Some embodiments provide facilitating contactless vehicle sharing. For facilitating such, a first request to use a vehicle from a user device associated with a first user can be received. After the first request is received, a first instruction can be transmitted to the user device instructing the first user to pick up the vehicle at a first location. A message can then be received from the user device—the message can include information indicating the message was transmitted by the user device at the first location. In response to receiving the message, a keep-alive request can be transmitted to the user device requesting the user device to repeatedly transmit the message from time to time at the first location. A determination can be made whether the message has been received for a first pre-determined number of times in a predetermined period. In response to the determination that the message has been received for the pre-determined number of times in the predetermined period, a second instruction instructing the vehicle to be driven to the first location can be transmitted to the user device. A second request from the user device to access the vehicle at the first location can be received from the user device. A determination whether the vehicle is at the first location can then be made. Another determination whether the second request is transmitted from the user device at the first location can also be made. Based on the determination that the vehicle is at the first location, and that the second request is from the first location, an access token for the first user to access the vehicle at the first location can be generated. The access token can be transmitted to the user device for the first user to access the vehicle at the first location.

In some embodiments, for facilitating the contactless car sharing, a determination whether the message has been received for a second predetermined number of times can be made. When it is determined that the message has not been received for the second predetermined number of times, a third request requesting the first user to be at the first location. The third request can be transmitted to the user device for presentation to the first user.

In some embodiments, in response to a determination that the second request is not transmitted from the first location, after the third request having been transmitted and a determination that a message indicating the user device is not at the first location, an instruction instructing the vehicle to return to a home location of the vehicle can be generated. In those embodiments, after the instruction instructing the vehicle to return to the home location of the vehicle is generated, a notification indicating that the vehicle has left the first location can be generated, and the notification can be transmitted to the user device for presentation to the first user.

Other objects and advantages of the disclosure will be apparent to those skilled in the art based on the following drawings and detailed description.

### BRIEF DESCRIPTION OF THE DRAWINGS

FIG. 1 generally illustrates a scenario for contactless car sharing.

FIG. 2 illustrates an example protocol for facilitating contactless car sharing.

FIG. 3 illustrates an exemplary method for facilitating contactless car sharing in accordance with the disclosure.

FIG. 4 generally illustrates a computer system that can be used to implement various embodiments in accordance with the disclosure.

### DETAILED DESCRIPTION

Car sharing is a model of car rental where people can rent cars for short periods of time. They are attractive to customers who make only occasional use of a vehicle, as well as others who would like occasional access to a vehicle of a different type than they use day-to-day. The organizations providing car sharing services may include commercial businesses, public agency, ad hoc grouping created by users, and/or any other entities. Car sharing is part of a larger trend of shared mobility. Shared mobility includes all modes of travel that offer short-term access to transportation on an on-needed basis either for personal transportation or goods delivery.

In this disclosure, car sharing may also refer to the traditional car rental services that let a user use a vehicle by days.

A self-driving car, also known as a robot car, autonomous car, auto, or driverless car is a vehicle that is capable of sensing its environment and moving with little or no human input. Autonomous cars combine a variety of sensors to perceive their surroundings, such as radar, computer vision, Lidar, sonar, GPS, odometer and inertial measurement units. Advanced control systems interpret sensory information to identify appropriate navigation paths, as well as obstacles and relevant signage.

Contactless car sharing service is a combination of traditional car sharing and self-driving technology. With this service, a user may be enabled to reserve a vehicle of his/her choice using a device associated with this user, for example a smart phone. The vehicle, once successfully reserved by the user, may be dispatched to a pickup location for the user. In this service, the vehicle is typically equipped with self-driving technology. After being dispatched to the pickup location, the vehicle can drive itself to the pickup location. An important aspect of the contactless car sharing is the entire process may be completed without a human operator's intervention. That is, in the traditional car sharing service, some form of human operator's intervention is needed so long as the vehicle is dispatched to a pickup location. For example, in the traditional car rental service, the user is required to physically be present at a car rental location and a clerk typically helps the user complete the rental transaction necessary for the user to access the vehicle. In some more advanced car sharing services, the transactions may be completed online without a human operator's disclosure, but a human operator is still needed to drive the car to the pickup location because cars in those services are not equipped with self-driving technology.

It should be understood the contactless car sharing service concerned by this disclosure is different from the short term car sharing service generally known (e.g., Zipcar). Although, it may be argued that the short term car sharing service is also contactless in the sense no human operator is needed for a user of such a service to access a car provided by the service, this kind of service does not dispatch the car to a pickup location. That is, cars provided by such a service are parked at their home locations and the user is required to go to the home locations to access the car.

Thus, the contactless car sharing concerned by this disclosure involves contactless transaction completion and as well as self-driving of a reserved vehicle to a pickup location. One key technical challenge for facilitating such a service is management of liability when the reserved vehicle is on road while the user has not accessed the vehicle. In the traditional car sharing services, whether the car is at the rental location or at its home location, the user is permitted to access the car only after he/she is present at such a location. That is, in those services, the user is “tended” with the reserved car only at the location where there is security or monitoring around the car. Even in the case of home location, there is typically security monitoring around the car.

However, in the contactless car sharing service, a vehicle may be dispatched to a pickup location where there is no security (e.g., restricted access through a gate) or even monitoring. What if the vehicle has arrived at the pickup location and the user is not present at the pickup location, and the vehicle is damaged during the time when the user is not present at the pickup location. While one solution to this challenge is to assign the liability to the user once the vehicle is at the pickup location, the user may not think that is fair particularly when there is a situation preventing the user from being at the pickup location when the vehicle has arrived at the pickup location. Such a liability allocation would put too much of a burden on the user to be at the pickup location and thus reduces desirability of this service for the user.

One insight provided by this disclosure is a protocol facilitating the aforementioned contactless car sharing by ensuring when the reserved vehicle arrives at the pickup location, the user is at the pickup location to access the vehicle immediately, and thus the vehicle is immediately tended to the user as soon as the vehicle has arrived at the pickup location. For achieving this, a few measures are provided. First, before the vehicle is dispatched to the pickup location, the user may be requested to transmit a message to a server of a car sharing service provider that the user has arrived at the pickup location. The user may be requested to transmit this message for a predetermined number of times before the reserved vehicle is dispatched to the pickup location. This can ensure that the user has arrived at the pickup location before the vehicle is dispatched, and ensure that the user has a reliable communication with the server of the car sharing service provider.

Second, during the vehicle is being dispatched to the pickup location, the user may be requested to send a number of keep-alive messages indicating that the user is still at the pickup location. This can ensure that the user is reliably at the pickup location when the vehicle arrives at the pickup location. If during that period, the user fails to send this number of keep-alive messages, a notification may be generated to notify the user that he/she needs to be at the pickup location all time when the vehicle is on its way to the pickup location. If after such a notification or notifications has or have been sent and the user still fails to send this number of keep-alive messages, an instruction may be generated instructing the vehicle to return to its home location.

Third, after the vehicle has arrived at the pickup location, the user may be requested to send a request to access the vehicle immediately. This request may be required to be sent from the pickup location. For example, a notification may be transmitted to the user indicating that the vehicle has arrived at the pickup location, and requesting the user to send the request immediately. This can ensure that the user is indeed present at the pickup location after the reserved vehicle has arrived at the pickup location.

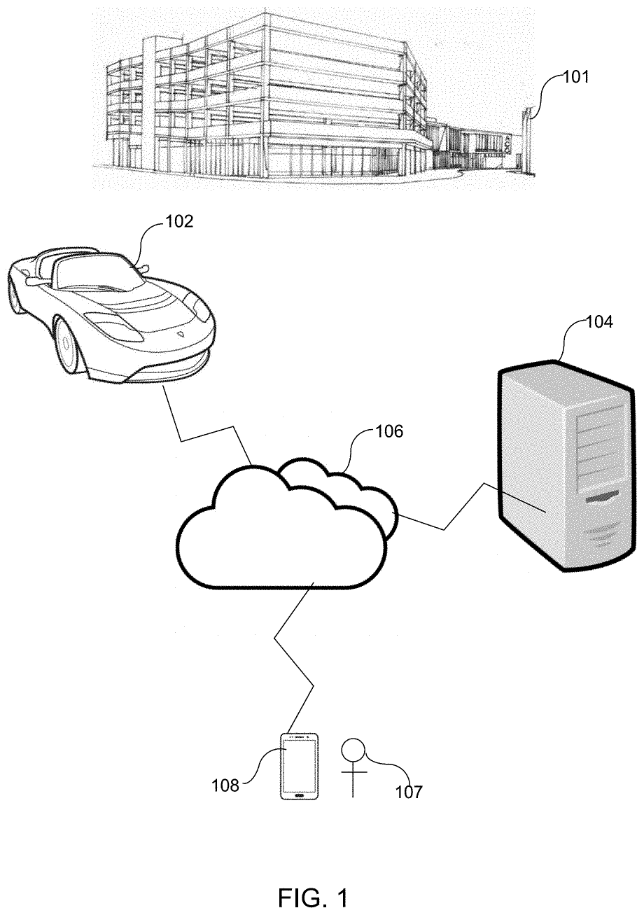

FIG. 1 generally illustrates a scenario where the aforementioned contactless car sharing service is provided. As shown, in the contactless car sharing service in accordance with the disclosure, a parking space 101 may be provided for a vehicle 102. The parking space 101 may be provided by a car sharing service provider, such as a rental car company, a car sharing organizing service, a public agency, or any other entity that may provide the contactless car sharing in accordance with the disclosure. Vehicle 102 may include a car, a bus, a train, a truck, a tram, or any other type of vehicle. Vehicle 102 may be equipped self-driving technology such that it is capable of driving to a location autonomously. In one example, vehicle 102 is an self-driving electrical automobile.

In various embodiments, vehicle 102 may be equipped with one or more communication modules capable of communicating with a remote device wirelessly or through a wire. In various embodiments, vehicle 102 may include one or more processors, such as a vehicle control unit, for processing/generating/executing various instructions and/or commands. As also shown in FIG. 1 is a computer server 104. The computer server 104 may be provided by the aforementioned car sharing service provider to facilitate the contactless car sharing in accordance with the disclosure.

Still shown in FIG. 1 is a user device 108 associated with a user 107. The user device 108 may be configured to communicate with the computer server 104 and/or vehicle 102. As disclosed herein, the user device 108 may be configured help user 107 to perform: reserving vehicle 102 remotely, communicating with computer server 104 and/or vehicle 102 indicating that user 107 is at the pickup location, requesting an access token for accessing vehicle 102 at the pickup location, and/or any other functions. Examples of user device 108 may include a smartphone, a tablet computer, a netbook, a laptop computer, a desktop computer, and/or any other types of user device.

As mentioned above, user device 108 is a key device for facilitating the contactless car sharing. For one this device needs to be reliable when communicating with computer server 104 and/or vehicle 102 when vehicle 102 has been dispatched to the pickup location. This device essentially serves as a point of “contact” for the user 107 in this contactless car sharing service. If somehow the communication with user device 108 breaks down or becomes unreliable before the vehicle 102 is tended to the user 107, the reliability that the vehicle 102 can be tendered to the user 107 at the pickup location cannot be guaranteed. Thus, clear and consistent communication with the user device 108 by computer server 104 and/or vehicle 102 is essential in the contactless car sharing service in accordance with the disclosure. Thus, the aforementioned measures are designed to consistently check-in with the user device 108 and thus the user 107 before the vehicle 102 arrives at the pickup location. Lapse between arrival of the vehicle 102 at the pickup location and user 107's presence at the pickup location may not be tolerated in this contactless car sharing service. Such a lapse may result in the user device 108 being damaged while at the pickup location.

Also shown in FIG. 1 is a network 106, which can facilitate communications among vehicle 102, computer server 104, user device 108 and/or any other devices. Examples of network 106 may include the Internet or a secured communication platform such as vehicle cloud platform. Network 106 is not specifically limited herein and one skilled in the art would understand it may include any type of communication network (wireless and/or wired) to facilitate contactless car sharing in accordance with the disclosure.

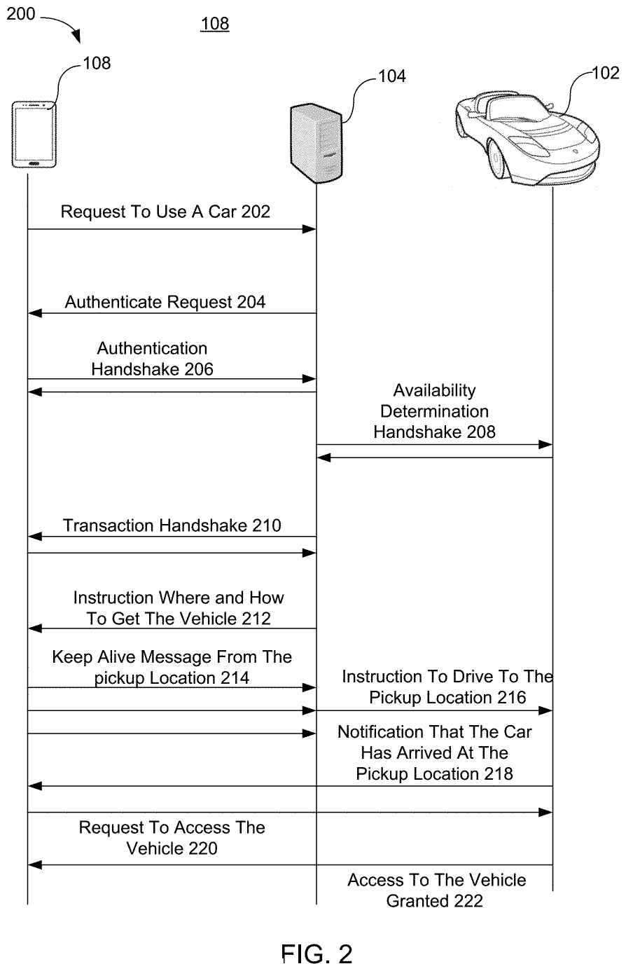

With a scenario of the contactless car sharing in accordance with the disclosure has been generally described, attention is now directed to FIG. 2, where an example protocol 200 for facilitating contactless car sharing in accordance with the disclosure is illustrated. FIG. 2 will be described with reference to FIG. 1.

At 202, a request for using a vehicle 102 can be generated by user device 108. This request can include information regarding the user 107, a manner for using vehicle 102, and/or any other elements. The information regarding user 107 can include information indicating an identity of the user, a current location of the user 107, and/or any other information regarding user 107. The information regarding the manner for sharing the vehicle 102 may include a time window during which the user 107 desires to use vehicle 102, a type of vehicle 102 desired by user 107 for the sharing experience, and/or any other information regarding the manner for sharing the vehicle 102.

In some embodiments, the request generated at 202 can include information indicating a pickup location where the user desires to pick up the vehicle 102. However, this is not intended to be limiting. In some other embodiments, the request may simply include the current location of the user 107 when the request is made.

By way of example, below is an example request that may be generated at 202. User 107 may, through user device 108, generate a request to use vehicle 102 at a specific time (e.g. 30 minutes later from now). In this request, the user 107 may specify a pickup location for picking up vehicle 102, e.g. at a particular public partaking space close to user 107.

Still at 202, the generated request may be transmitted to the computer server 104 as shown, for example through the network 106.

At 204, the computer server 104 may send an authentication request to the user device 108 requesting the user device 108 to authenticate itself.

At 206, authentication handshakes may be carried out between user device 108 and computer server 104 to authenticate the user device 108.

At 208, after the user device 108 has been successfully authenticated, computer server 104 may determine availability of vehicle 102. Such a determination may include consulting with a database associated with the computer server 104 for availability of the vehicle 102 during the time window the user 107 desires to use vehicle 102 as indicated in the request generated 202. Such a determination may be quite complicated in some embodiments. Since this is not a focus of this disclosure, it will not be explained in great details.

At 210, after a determination that the vehicle 102 is available as requested by the user 107, computer server 104 may initiate transaction handshakes with the user device 108. This may involve obtaining necessary information regarding the user 107 such as driving history and insurance coverage to ensure the user 107 will be responsible for vehicle 102 during the time when the user 107 uses the vehicle 102. Since this is not a focus of this disclosure, it will not be explained in great details.

At 212, after the transaction is completed with the user device 108, the computer server 104 may generate an instruction instructing user 107 when and where to pick up vehicle 102. As mentioned above, in some embodiments, the request generated at 202 may include a pick up location desired by user 107. In those embodiment, the instruction generated at 212 may include such a pickup location. However, this is not necessarily the only as also mentioned above. In some other embodiments, the computer server 104 may be configured to determine the pickup location based on the current location of the user 107 when the request is transmitted at 202. This may involve selecting one or more candidate locations based on driving regulations within an area close to the current location of the user 107. For example, certain locations in the area may be more suitable for the user 107 to pick up vehicle 102 because of it's easier for the vehicle 102 to be self-driven to those locations. In some embodiments, the computer server 104 may be configured to select the pickup location from the candidate locations based on their distance to the current location of the user 107. In some other embodiments, the computer server 104 may be configured to generate a request to have user 107 to select the pickup location from the candidate locations. In any case, the instruction generated at 212 includes information indicating the pickup location.

Also at 212, the generated instruction is transmitted to the user device 108 for presentation to the user 107.

At 214, keep-alive messages may be received from the user device 108. As mentioned above, a given keep-alive message received at 214 may indicate that the user device 108 is at the pickup location. In some embodiments, the given keep-alive message may only generated

At 216, an instruction instructing the vehicle 102 to drive itself to the pickup location may be generated by computer server 104. As mentioned above, in some embodiments, the instruction generated at 216 may be generated only after a certain number of keep-alive messages has been received from the user device 108 in a time period. For example, it may be predetermined that at least 5 number of the keep-alive messages should be received within a time window starting from the time when the first keep-alive message is received before such an instruction is generated. It may also be determined that the at least 5 keep-alive messages must be received within, for example 5 minutes from the time when the first keep-alive message is received. As mentioned above, in this way, it may be ensured that the user 107 is present at the pickup location the instruction is generated to dispatch the vehicle 102 to the pickup location.

Also mentioned above is that in some embodiments, the computer server 104 may be configured to determine another number of keep-alive messages have been received from user device 108 when the vehicle 102 is being dispatched to the pickup location. For example, after the instruction is generated at 216 to dispatch the vehicle 102 to the pickup location, a clock may be started to count a number of keep-alive messages received until the vehicle 102 arrives at the pickup location. The counted a number of keep-alive messages may then compared to one or more thresholds to determine whether the user 107 is consistently at the pickup location. As explained above, such a measure is for estimating whether the user 107 will be at the pickup location when the vehicle 102 arrives at the pickup location. Schemes of such comparison can be simple or quite complex. For example, in a simple case, a threshold of 10 may be configured such that the user device 108 must send the keep-alive message from the pickup location 10 times until the vehicle 102 arrives at the pickup location. As another example, stepped thresholds may be configured such that for the first 5 minutes 2 keep-alive messages should be received, for the next 5 minutes, 5 keep-alive messages should be received, and for the last minutes 10 keep-alive messages should be received. Stepped-up polling may help ensure that as the vehicle 102 is getting closer and closer to the pickup location, more reliability is required from the user 107 to be at pickup location.

At 218, after vehicle 102 arrives at the pickup location, a notification can be generated to by computer server 104. The notification can include information indicating that the vehicle 102 has arrived at the pickup location. As shown, the notification can be transmitted to user device 108 for presentation to the user 107.

At 220, a request to access vehicle 102 can be generated by the user device 108. The request can include information indicating that user 107 would like to access the vehicle 102 at the pickup location, a time stamp indicating a current time when the request is generated, a current location of user device 108 when the request is generated, and/or any other information. As also shown the request can be transmitted to computer server 104 and/or vehicle 102 for processing.

At 222, a determination may be made as to whether a grant may be generated for user device 108 to access vehicle 102 as requested at 220. As mentioned above, operations at 222 may involve determining whether the location when the request was sent is the pickup location. This can ensure that access to the vehicle 102 may only be granted to the user device 108 when it is at the pickup location. The grant may include information that can assist user device 108 to open the vehicle 102 and/or star operating vehicle 102. Example of such information may include a secret token key that can open and start vehicle 102 for within a period of time (for example, within the next minute). As can be seen, the grant can then be transmitted to the user device 108 for accessing the vehicle 102. It should be understood that operations involved in 222 may be performed at computer server 104 and/or at vehicle 102. For example, in some embodiments, computer server 104 may be configured to receive the request generated at 220 and grant the access. In some other embodiments, vehicle 102 may be configured to receive the request generated at 220 and grant the access. Still in some other embodiments, a combination of computer server 104 and vehicle 102 may be used to receive the request generated at 220 and grant the access.

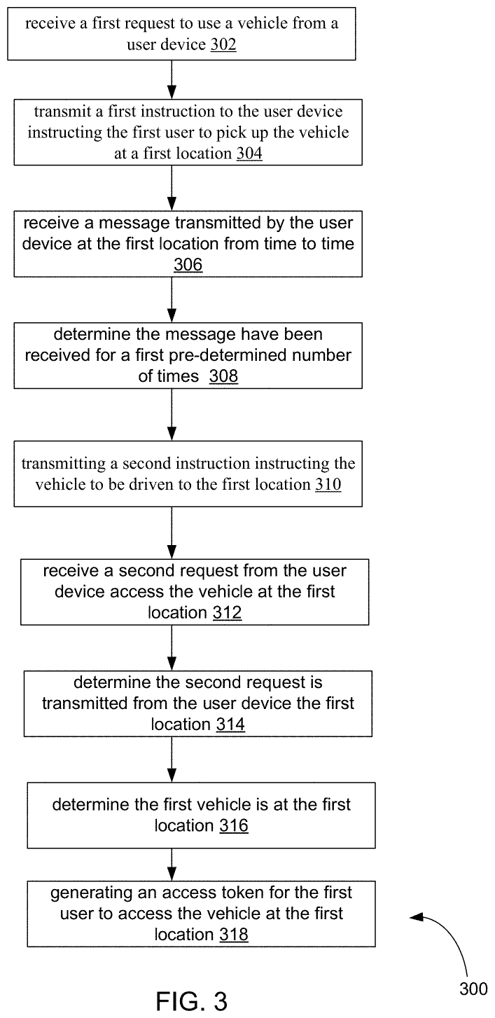

FIG. 3 illustrates one exemplary method 300 for facilitating car sharing in accordance with the disclosure. The operations of method 300 presented below are intended to be illustrative. In some embodiments, method 300 may be accomplished with one or more additional operations not described and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300. In some embodiments, method 300 may be implemented by a computer server such as the computer server 104 shown in FIG. 1.

At an operation 302, a first request to use a vehicle may be received from a user device. The request received 302 may include information indicating a specific time (e.g. 30 minutes later from now) when the vehicle is to be used, a proposed pickup location where the vehicle is to picked up for the use, identification information regarding a user making the request, and/or any other information.

At an operation 304, a first instruction may be generated and transmitted to the user device. The first instruction may include information indicating a pickup location for the vehicle. As mentioned above, the pickup location in the first instruction may be the proposed pickup location in the request received at 302. However this is not necessarily the only case. In some embodiments, based on the proposed pickup location, the “final” pickup location may be determined. For example, based on the proposed pickup location, a few candidate locations may be determined by virtue of them being on self-drivable routes for the vehicle. In that example, the “final” pickup location may be selected based on a distance between the “final” pickup location and the proposed pickup location is the shortest among all candidate locations. Other examples are contemplated.

At an operation 306, a message may be received from the user device from time to time. As described herein, the message received at 306 may include information indicating a current location of the user device 108 when the message is sent. This message may be scheduled to transmitted to computer server 104 after authentication and transaction are completed as shown in FIG. 2. At that point, such a message may be generated by user device 108 and transmitted to the computer server 104 as a “keep-alive” message indicating that user device 108 is at the pickup location.

At an operation 308, a determination may be made that the “keep-alive” message indicating that the user device 108 is at the pickup location has been received for more than a predetermined amount of times. For example, it may be predetermined that at least 5 number of the keep-alive messages should be received within a time window starting from the time when the first keep-alive message is received before such an instruction is generated. It may also be determined that the at least 5 keep-alive messages must be received within, for example 5 minutes from the time when the first keep-alive message is received. As mentioned above, in this way, it may be ensured that the user 107 is present at the pickup location the instruction is generated to dispatch the vehicle 102 to the pickup location.

In some embodiments, this number of times the “keep-alive” message should be received may be changed from time to time. This can prevent the user 107 from guessing the number. For example, as illustration, every time when the user 107 requests to use the user device 108, this number may be randomly generated within a predetermined threshold (e.g., any number between 5 and 10). In this way, the user 107 may not guess or estimate what the number is. In some embodiments, the determination performed at 308 may be carried out at a frequency that can also change from time to time. For example, as illustration, the determination may be made once every 30 seconds for 5 minutes this time, and once every 20 seconds for 7 minutes next time. This also can prevent the user from being leaving the pickup location too early. For instance, if the user 107 transmits all 5 numbers of keep-alive messages within a minute and thus satisfies the requirement, he/she may leave the pickup location and thus defeats a purpose of this keep-alive message.

In implementations, the duration in which the determination may be performed may start from a specific time or the time when the first keep-alive message is received from the user device 108. This may be a design choice depending on the situation. For example, user 107 may be instructed by the computer server 104 to be at the pickup location within next 5 minutes such that the user device 108 should transmit 5 number of keep-alive messages from the pickup location within the next 5 minutes. As another example, user 107 may be instructed by computer server 104 to be at the pickup location within next 5 minutes such that the user device 108 should transmit 5 number of keep-alive messages from the pickup location after the user 107 arrives at the pickup location within the next 5 minutes.

In some embodiments, when it is determined that the keep-alive messages are not received for the predetermined amount of times, a notification may be generated. This notification can include information indicating the user should be at the pickup location immediately and stay there, otherwise vehicle 102 will not be dispatched. This notification can be transmitted to user device 108 for presentation to the user 107.

At operation 310, a second instruction can be transmitted to vehicle 102 to instruct vehicle 102 to drive itself to the pickup location after it is determined that the keep-alive messages has been received for the predetermined number of times. In some implementations, after the second instruction is transmitted to vehicle 102, it may be determined whether another number of keep-alive messages are received from user device 108 before the vehicle 102 arrives at the pickup location. For example, after the instruction is transmitted to dispatch the vehicle 102 to the pickup location, a clock may be started to count a number of keep-alive messages received until the vehicle 102 arrives at the pickup location. The counted a number of keep-alive messages may then compared to one or more thresholds to determine whether the user 107 is consistently at the pickup location. As explained above, such a measure is for estimating whether the user 107 will be at the pickup location when the vehicle 102 arrives at the pickup location.

Schemes of such comparison can be simple or quite complex. For example, in a simple case, a threshold of 10 may be configured such that the user device 108 must send the keep-alive message from the pickup location 10 times until the vehicle 102 arrives at the pickup location. As another example, stepped thresholds may be configured such that for the first 5 minutes 2 keep-alive messages should be received, for the next 5 minutes, 5 keep-alive messages should be received, and for the last minutes 10 keep-alive messages should be received. Stepped-up polling may help ensure that as the vehicle 102 is getting closer and closer to the pickup location, more reliability is required from the user 107 to be at pickup location.

In some embodiments, a notification may be generated after it is determined the number of keep-alive messages received after the vehicle 102 is dispatched is less than the predetermined number. The notification may include information indicating that user 107 should be present at the pickup location while the vehicle 102 is being dispatched the pickup location. In some embodiments, a number of such notifications may be transmitted to user device 108 to remind the user 107 to be at the pickup location after vehicle 102 is dispatched. In those embodiments, if after these notifications (e.g., 3) have been transmitted, and still the user device 108 fails to transmit the predetermined number of keep-alive messages from the pickup location, an instruction may be generated to instruct the vehicle 102 to return to its home location. Another notification may be generated to information user 107 that vehicle 102 has returned to the home location, and the transaction has been cancelled.

At 312, a second request can be received from the user device 108. The second request may include information indicating the user 107 requests to access vehicle 102 at the pickup location, a time stamp indicating a current time when the request is generated, a current location of user device 108 when the request is generated, and/or any other information.

At 314, a determination can be made whether the second request is transmitted from the user device 108 at the pickup location. This can ensure that access to the vehicle 102 may only be granted to the user device 108 when it is at the pickup location

At 318, an access token may be generated after it is determined that the second request is transmitted from the pickup location. The access token may include information that can assist user device 108 to open the vehicle 102 and/or star operating vehicle 102. Example of such information may include a secret token key that can open and start vehicle 102 for within a period of time (for example, within the next minute).

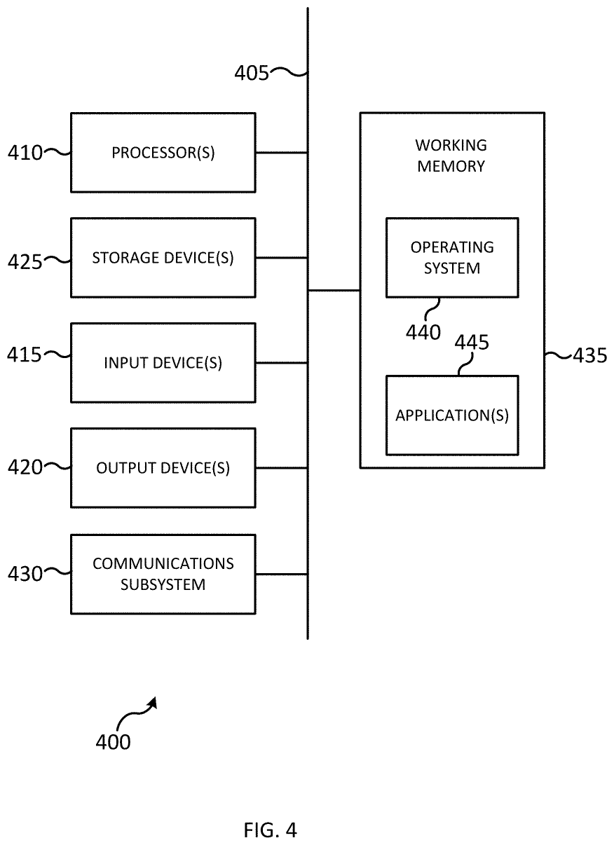

FIG. 4 illustrates a simplified computer system that can be used implement various embodiments described and illustrated herein. A computer system 400 as illustrated in FIG. 4 may be incorporated into devices such as a portable electronic device, mobile phone, or other device as described herein. FIG. 4 provides a schematic illustration of one embodiment of a computer system 400 that can perform some or all of the steps of the methods provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 404, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 414, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 424, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, an 402.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g. the first electronic device, may be incorporated into the computer system 400, e.g., an electronic device as an input device 414. In some embodiments, the computer system 400 will further comprise a working memory 434, which can include a RAM or ROM device, as described above.

The computer system 400 also can include software elements, shown as being currently located within the working memory 434, including an operating system 440, device drivers, executable libraries, and/or other code, such as one or more application programs 444, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 424 described above. In some cases, the storage medium might be incorporated within a computer system, such as computer system 400. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform methods in accordance with various embodiments of the technology. According to a set of embodiments, some or all of the procedures of such methods are performed by the computer system 400 in response to processor 410 executing one or more sequences of one or more instructions, which might be incorporated into the operating system 440 and/or other code, such as an application program 444, contained in the working memory 434. Such instructions may be read into the working memory 434 from another computer-readable medium, such as one or more of the storage device(s) 424. Merely by way of example, execution of the sequences of instructions contained in the working memory 434 might cause the processor(s) 410 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 424. Volatile media include, without limitation, dynamic memory, such as the working memory 434.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 404 then might carry the signals and/or the data, instructions, etc. carried by the signals to the working memory 434, from which the processor(s) 410 retrieves and executes the instructions. The instructions received by the working memory 434 may optionally be stored on a non-transitory storage device 424 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A method for facilitating contactless vehicle sharing, the method being implemented by a processor configured to execute machine-readable instructions, the method comprising:
receiving a first request to use a vehicle from a user device associated with a first user;
transmitting a first instruction to the user device instructing the first user to pick up the vehicle at a first location;
receiving a message from the user device, the message includes information indicating the message was transmitted by the user device at the first location;
in response to receiving the message, transmitting a keep-alive request to the user device requesting the user device to repeatedly transmit the message from time to time;
determining whether the message has been received for a first pre-determined number of times in a predetermined period;
in response to the determination that the message has been received for the pre-determined number of times in the predetermined period, transmitting a second instruction instructing the vehicle to be driven to the first location;
receiving a second request from the user device to access the vehicle at the first location;
determining the vehicle is at the first location;
determining whether the second request is transmitted from the user device at the first location;
based on the determination that the vehicle is at the first location, and that the second request is from the first location, generating an access token for the first user to access the vehicle at the first location; and
transmitting the access token to the user device.

2. The method of claim 1, further comprising:
determining whether the message has been received for a second predetermined number of times;
when it is determined that the message has not been received for the second predetermined number of times:
generating a third request requesting the first user to be at the first location; and
transmitting the third request to the user device for presentation to the first user.

3. The method of claim 1, further comprising:
in response to a determination that the second request is not transmitted from the first location:
generating a third request requesting the first user to be at the first location; and
transmitting the third request to the user device for presentation to the first user.

4. The method of claim 3, further comprising:
after the third request having been transmitted and a determination that a message indicating the user device is not at the first location, generating an instruction instructing the vehicle to return to a home location of the vehicle.

5. The method of claim 4, further comprising:
after the instruction instructing the vehicle to return to the home location of the vehicle, generating a notification indicating that the vehicle has left the first location; and
transmitting the notification to the user device for presentation to the first user.

6. The method of claim 1, wherein the pre-determined period starts from the first time the message is received.

7. The method of claim 1, further comprising:
when it is determined that message has not been received for the first pre-determined number of times in the pre-determined period, generating a first notification notifying the first user to ensure a reliable communication channel.

8. The method of claim 1, wherein the vehicle is the first vehicle, the message is the first message and the user device is the first user device, and the method further comprises:
receiving a third request to use a second vehicle from a second user device associated with a second user;
transmitting a third instruction to the second user device instructing the second user to pick up the second vehicle at a second location;
receiving a second message from the second user device, the second message includes information indicating the second message was transmitted by the second user device at the second location;
in response to receiving the second message, transmitting a keep-alive request to the second user device requesting the second user device to repeatedly transmit the second message from time to time;
determining whether the second message has been received for the first pre-determined number of times in the predetermined period;
in response to the determination that the second message has been received for the first pre-determined number of times in the predetermined period, transmitting a fourth instruction instructing the second vehicle to be driven to the second location;
receiving a fourth request from the second user device to access the second vehicle at the second location;
determining the second vehicle is at the second location;
determining whether the fourth request is transmitted from the second user device at the second location;
based on the determination that the second vehicle is at the second location, and that the fourth request is from the second location, generating an access token for the second user to access the second vehicle at the second location; and
transmitting the access token to the second user device.

9. A system for facilitating contactless vehicle sharing, the system comprising a processor configured to execute machine-readable instructions such that when the machine-readable instructions are executed, the process is caused to perform:
receiving a first request to use a vehicle from a user device associated with a first user;
transmitting a first instruction to the user device instructing the first user to pick up the vehicle at a first location;
receiving a message from the user device, the message includes information indicating the message was transmitted by the user device at the first location;
in response to receiving the message, transmitting a keep-alive request to the user device requesting the user device to repeatedly transmit the message from time to time;
determining whether the message has been received for a first pre-determined number of times in a predetermined period;
in response to the determination that the message has been received for the pre-determined number of times in the predetermined period, transmitting a second instruction instructing the vehicle to be driven to the first location;
receiving a second request from the user device to access the vehicle at the first location;
determining the vehicle is at the first location;
determining whether the second request is transmitted from the user device at the first location;
based on the determination that the vehicle is at the first location, and that the second request is from the first location, generating an access token for the first user to access the vehicle at the first location; and
transmitting the access token to the user device.

10. The system of claim 9, wherein the processor is further caused to perform:
determining whether the message has been received for a second predetermined number of times;
when it is determined that the message has not been received for the second predetermined number of times:
generating a third request requesting the first user to be at the first location; and
transmitting the third request to the user device for presentation to the first user.

11. The system of claim 9, wherein the processor is further caused to perform:
in response to a determination that the second request is not transmitted from the first location:
generating a third request requesting the first user to be at the first location; and
transmitting the third request to the user device for presentation to the first user.

12. The system of claim 11, wherein the processor is further caused to perform:
after the third request having been transmitted and a determination that a message indicating the user device is not at the first location, generating an instruction instructing the vehicle to return to a home location of the vehicle.

13. The system of claim 12, wherein the processor is further caused to perform:
after the instruction instructing the vehicle to return to the home location of the vehicle, generating a notification indicating that the vehicle has left the first location; and
transmitting the notification to the user device for presentation to the first user.

14. The system of claim 9, wherein the pre-determined period starts from the first time the message is received.

15. The system of claim 9, wherein the processor is further caused to perform:
when it is determined that message has not been received for the first pre-determined number of times in the pre-determined period, generating a first notification notifying the first user to ensure a reliable communication channel.

16. The system of claim 9, wherein the vehicle is the first vehicle, the message is the first message and the user device is the first user device, and the processor is further caused to perform:
receiving a third request to use a second vehicle from a second user device associated with a second user;
transmitting a third instruction to the second user device instructing the second user to pick up the second vehicle at a second location;
receiving a second message from the second user device, the second message includes information indicating the second message was transmitted by the second user device at the second location;
in response to receiving the second message, transmitting a keep-alive request to the second user device requesting the second user device to repeatedly transmit the second message from time to time;
determining whether the second message has been received for the first pre-determined number of times in the predetermined period;
in response to the determination that the second message has been received for the first pre-determined number of times in the predetermined period, transmitting a fourth instruction instructing the second vehicle to be driven to the second location;
receiving a fourth request from the second user device to access the second vehicle at the second location;
determining the second vehicle is at the second location;
determining whether the fourth request is transmitted from the second user device at the second location;
based on the determination that the second vehicle is at the second location, and that the fourth request is from the second location, generating an access token for the second user to access the second vehicle at the second location; and
transmitting the access token to the second user device.
